(19) United States
(12) Patent Application Publication
(10) Pub. No.: US 2021/0014319 A1
(43) Pub. Date: Jan. 14, 2021

(54) NETWORK POLICY ENFORCEMENT FOR EXTERNALLY-HOSTED APPLICATION USAGE

(71) Applicant: HEWLETT PACKARD ENTERPRISE DEVELOPMENT LP, Houston, TX (US)

(72) Inventor: Antoni Milton, Santa Clara, CA (US)

(21) Appl. No.: 16/508,267

(22) Filed: Jul. 10, 2019

(51) Int. Cl. H04L 29/08; H04L 29/06

(52) U.S. Cl. CPC H04L 67/143; H04L 67/141; H04L 67/22; H04L 67/34; H04L 63/0892; H04L 63/10; H04L 67/306; H04L 67/42

(57) ABSTRACT

Systems and methods are provided for network policy enforcement for externally-hosted application usage. A method for a policy management server in an enterprise network includes: grant permission to a user of the enterprise network to access an application hosted outside the enterprise network; determine a usage of the application by the user subsequent to granting the permission; and revoke the permission responsive to the usage of the application by the user exceeding a predetermined usage limit of the application for the user.

### DESCRIPTION OF RELATED ART

The disclosed technology relates generally to data communication networks, and more particularly some embodiments relate to managing access to applications hosted in such networks.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates one example of a network configuration that may be implemented for an organization, such as a business, educational institution, governmental entity, healthcare facility or other organization.

FIG. 2 illustrates a system for network policy enforcement based on externally-hosted application usage according to an embodiment of the disclosed technology.

FIG. 3 illustrates one user profile according to an embodiment of the disclosed technology.

FIG. 4 illustrates a process that may be performed by the network policy enforcement system of FIG. 2 in accordance with the Remote Authentication Dial-In User Service (RADIUS) protocol according to an embodiment of the disclosed technology.

FIG. 5 is a block diagram of an example computing component or device for network access enforcement in accordance with one embodiment.

FIG. 6 is a block diagram of an example computing component or device for network access enforcement in accordance with one embodiment.

FIG. 7 depicts a block diagram of an example computer system in which embodiments described herein may be implemented.

The figures are not exhaustive and do not limit the present disclosure to the precise form disclosed.

### DETAILED DESCRIPTION

In enterprise networks, it is commonplace to limit the amount of access to external networks granted to each user. For example, this access may be limited to certain hours of the day, to a certain number of hours per day, to a certain amount of data per day, and the like. According to this disclosure, network access limitations may be enforced, not only by user, but also by application. For example, a user may be limited to a certain number of hours per day of access to a particular streaming video service, a certain amount of data per day of access to a particular social network application, and the like. In some implementations, this usage-based enforcement is implemented using the Remote Authentication Dial-In User Service (RADIUS) protocol. In this disclosure the terms “application” and “app” are used interchangeably.

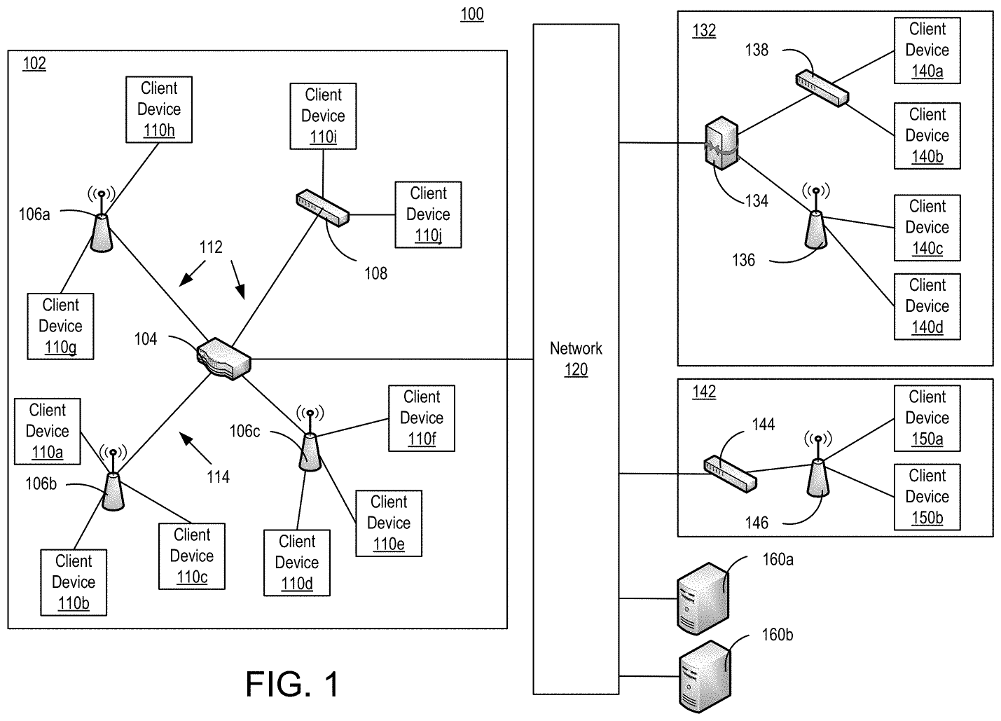

Before describing embodiments of the disclosed systems and methods in detail, it is useful to describe an example network installation with which these systems and methods might be implemented in various applications. FIG. 1 illustrates one example of a network configuration 100 that may be implemented for an organization, such as a business, educational institution, governmental entity, healthcare facility or other organization. This diagram illustrates an example of a configuration implemented with an organization having multiple users (or at least multiple client devices 110) and possibly multiple physical or geographical sites 102, 132, 142. The network configuration 100 may include a primary site 102 in communication with a network 120. The network configuration 100 may also include one or more remote sites 132, 142, that are in communication with the network 120.

The primary site 102 may include a primary network (not shown), which can be, for example, an office network, home network or other network installation. The primary site 102 network may be a private network, such as a network that may include security and access controls to restrict access to authorized users of the private network. Authorized users may include, for example, employees of a company at primary site 102, residents of a house, customers at a business, and so on.

In the illustrated example, the primary site 102 includes a controller 104 in communication with the network 120. The controller 104 may provide communication with the network 120 for the primary site 102, though it may not be the only point of communication with the network 120 for the primary site 102. A single controller 104 is illustrated, though the primary site may include multiple controllers and/or multiple communication points with network 120. In some embodiments, the controller 104 communicates with the network 120 through a router (not illustrated). In other embodiments, the controller 104 provides router functionality to the devices in the primary site 102.

A controller 104 may be operable to configure and manage network devices, such as at the primary site 102, and may also manage network devices at the remote sites 132, 134. The controller 104 may be operable to configure and/or manage switches, routers, access points, and/or client devices connected to a network. The controller 104 may itself be, or provide the functionality of, an access point.

The controller 104 may be in communication with one or more switches 108 and/or wireless Access Points (APs) 106a-c. Switches 108 and wireless APs 106a-c provide network connectivity to various client devices 110a-j. Using a connection to a switch 108 or AP 106a-c, a client device 110a-j may access network resources, including other devices on the (primary site 102) network and the network 120.

Examples of network devices and servers devices may include: desktop computers, laptop computers, servers, web servers, authentication servers, authentication-authorization-accounting (AAA) servers, Domain Name System (DNS) servers, Dynamic Host Configuration Protocol (DHCP) servers, Internet Protocol (IP) servers, Virtual Private Network (VPN) servers, network policy servers, mainframes, tablet computers, e-readers, netbook computers, televisions and similar monitors (e.g., smart TVs), content receivers, set-top boxes, personal digital assistants (PDAs), mobile phones, smart phones, smart terminals, dumb terminals, virtual terminals, video game consoles, virtual assistants, Internet of Things (IOT) devices, and the like.

Within the primary site 102, a switch 108 is included as one example of a point of access to the network established in primary site 102 for wired client devices 110i-j. Client devices 110i-j may connect to the switch 108 and through the switch 108, may be able to access other devices within the network configuration 100. The client devices 110i-j may also be able to access the network 120, through the switch 108. The client devices 110i-j may communicate with the switch 108 over a wired 112 connection. In the illustrated example, the switch 108 communicates with the controller 104 over a wired 112 connection, though this connection may also be wireless.

Wireless APs 106a-c are included as another example of a point of access to the network established in primary site 102 for client devices 110a-h. Each of APs 106a-c may be a combination of hardware, software, and/or firmware that is configured to provide wireless network connectivity to wireless client devices 110a-h. In the illustrated example, APs 106a-c can be managed and configured by the controller 104. APs 106a-c communicate with the controller 104 and the network over connections 112, which may be either wired or wireless interfaces.

The network configuration 100 may include one or more remote sites 132. A remote site 132 may be located in a different physical or geographical location from the primary site 102. In some cases, the remote site 132 may be in the same geographical location, or possibly the same building, as the primary site 102, but lacks a direct connection to the network located within the primary site 102. Instead, remote site 132 may utilize a connection over a different network, e.g., network 120. A remote site 132 such as the one illustrated in FIG. 1 may be, for example, a satellite office, another floor or suite in a building, and so on. The remote site 132 may include a gateway device 134 for communicating with the network 120. A gateway device 134 may be a router, a digital-to-analog modem, a cable modem, a Digital Subscriber Line (DSL) modem, or some other network device configured to communicate to the network 120. The remote site 132 may also include a switch 138 and/or AP 136 in communication with the gateway device 134 over either wired or wireless connections. The switch 138 and AP 136 provide connectivity to the network for various client devices 140a-d.

In various embodiments, the remote site 132 may be in direct communication with primary site 102, such that client devices 140a-d at the remote site 132 access the network resources at the primary site 102 as if these clients devices 140a-d were located at the primary site 102. In such embodiments, the remote site 132 is managed by the controller 104 at the primary site 102, and the controller 104 provides the necessary connectivity, security, and accessibility that enable the remote site 132's communication with the primary site 102. Once connected to the primary site 102, the remote site 132 may function as a part of a private network provided by the primary site 102.

In various embodiments, the network configuration 100 may include one or more smaller remote sites 142, comprising only a gateway device 144 for communicating with the network 120 and a wireless AP 146, by which various client devices 150a-b access the network 120. Such a remote site 142 may represent, for example, an individual employee's home or a temporary remote office. The remote site 142 may also be in communication with the primary site 102, such that the client devices 150a-b at remote site 142 access network resources at the primary site 102 as if these client devices 150a-b were located at the primary site 102. The remote site 142 may be managed by the controller 104 at the primary site 102 to make this transparency possible. Once connected to the primary site 102, the remote site 142 may function as a part of a private network provided by the primary site 102.

The network 120 may be a public or private network, such as the Internet, or other communication network to allow connectivity among the various sites 102, 130 to 142 as well as access to servers 160a-b. The network 120 may include third-party telecommunication lines, such as phone lines, broadcast coaxial cable, fiber optic cables, satellite communications, cellular communications, and the like. The network 120 may include any number of intermediate network devices, such as switches, routers, gateways, servers, and/or controllers, which are not directly part of the network configuration 100 but that facilitate communication between the various parts of the network configuration 100, and between the network configuration 100 and other network-connected entities. The network 120 may include various content servers 160a-b. Content servers 160a-b may include various providers of multimedia downloadable and/or streaming content, including audio, video, graphical, and/or text content, or any combination thereof. Examples of content servers 160a-b include, for example, web servers, streaming radio and video providers, and cable and satellite television providers. The client devices 110a j, 140a-d, 150a-b may request and access the multimedia content provided by the content servers 160a-b.

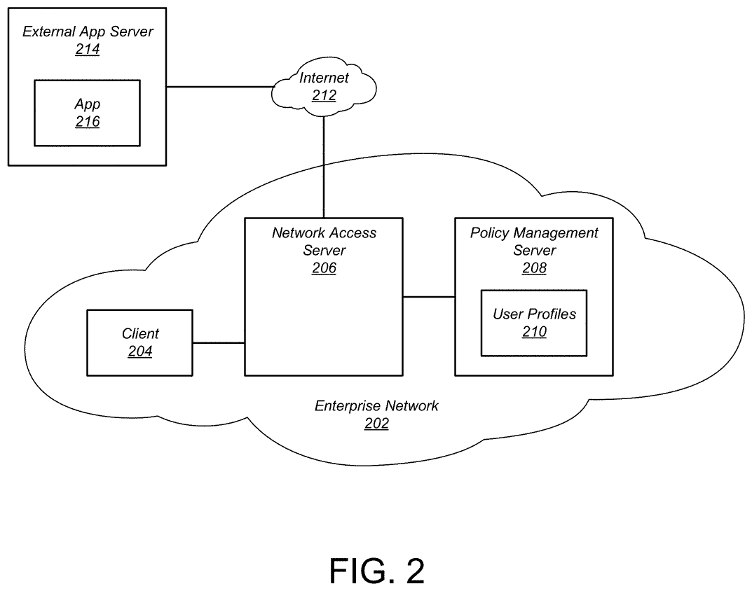

FIG. 2 illustrates a system for network policy enforcement based on externally-hosted application usage according to an embodiment of the disclosed technology. Referring to FIG. 2, the system 200 may include an enterprise network 202. The disclosed technology is discussed with reference to enterprise networks. However it will be appreciated to one skilled in the relevant arts that the disclosed technology may be applied to other sorts of networks.

The enterprise network 202 may include a client 204. The client 204 may be implemented in hardware, software or some combination thereof. The client 204 may include any sort of network device, for example such as a computer, laptop, smart phone, or the like. In the disclosed embodiments, a user of the client 204 seeks access to an application 216 hosted outside the enterprise network 202.

The network policy enforcement system 200 may include an external app server 214. The external app server 214 is referred to as “external” because it is located outside the enterprise network 202. The external app server 214 may be implemented in hardware, software, or some combination thereof. The external app server 214 may host one or more apps 216. The apps 216 may include any app. For example, the apps 216 may include streaming video apps, streaming music apps, social media apps, and the like.

The enterprise network 202 may include a network access server 206, and a policy management server 208. Each of the servers 206, 208 may be implemented in hardware, software, or some combination thereof. The network access server 206 may grant the client 204 access to external apps 216 in accordance with one or more network management policies. For example, access to apps 216 hosted on the external app server 214 may be provided by the network access server 206 over an external network such as the Internet 212.

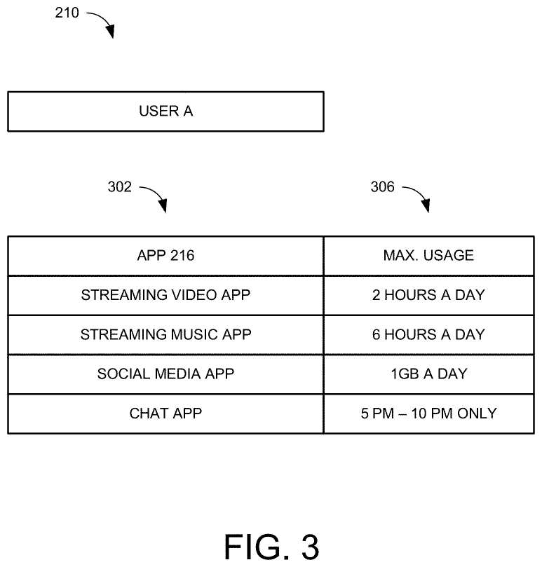

The policy management server 208 may implement all or part of the Aruba Networks ClearPass technology. The policy management server 208 may store one or more of the network access policies in one or more user profiles 210. Each user may have a separate user profile 210. FIG. 3 illustrates one user profile 210 according to an embodiment of the disclosed technology.

Referring to FIG. 3, an example user profile 210 for a “USER A” lists a number of apps 216, at 302, and for each of the apps 216, a usage limit 306. The usage limit may be specified in terms of hours per day of usage. For example, in FIG. 3, the usage limit for the streaming video app is two hours a day, and the usage limit for the streaming music is six hours a day. The usage limit may be specified in terms of data usage per period of time. For example, in FIG. 3, the usage limit for the social media app is 1 GB per day. The usage limit may be specified as a period of time. For example, in FIG. 3, the chat app may only be used between hours of 5 PM and 10 PM. However, these usage limits are given only by way of example. Any usage limit may be employed. Some apps 216 may have no usage limits. These apps 216 may not be listed in a user profile 210.

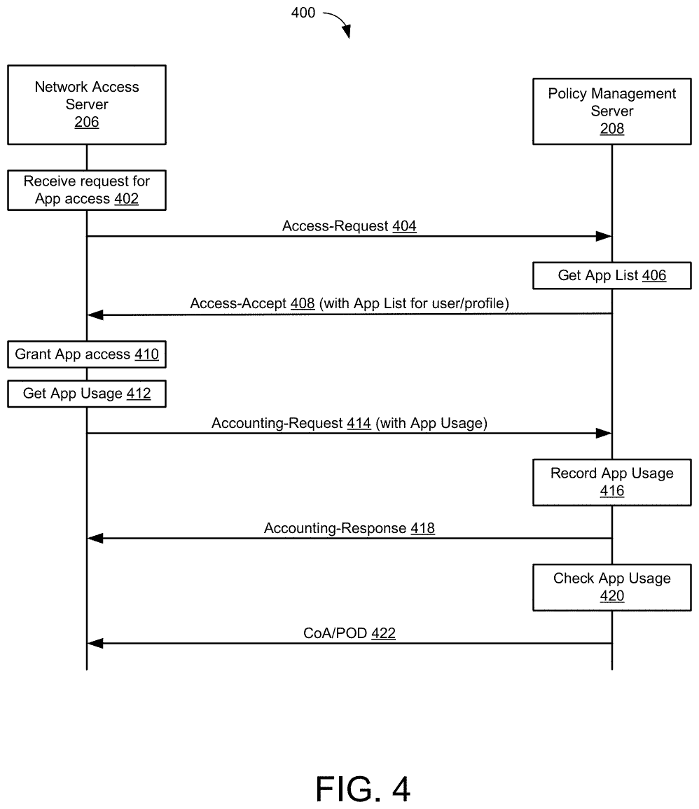

FIG. 4 illustrates a process that may be performed by the network policy enforcement system 200 of FIG. 2 in accordance with the Remote Authentication Dial-In User Service (RADIUS) protocol according to an embodiment of the disclosed technology. But as discussed below, other embodiments may operate independently of the RADIUS protocol.

Referring to FIG. 4, the network access server 206 may receive a request 402 for access to an app 216 hosted outside the enterprise network 202. The request 402 may be received from a client 204 of the enterprise network 202. Responsive to receiving the request, the network access server 206 may transmit a RADIUS Access-Request message 404 to the policy management server 208.

Responsive to the RADIUS Access-Request message 404, the policy management server may get a list of apps 216 the user of the client 204 is authorized to access, at 406. The list of apps may be indexed by information concerning the user, information concerning the client 204, or some combination thereof. The information concerning the user may include login information, and the like. The information concerning the client 204 may include a media access control (MAC) address of the client 204, and the like. The policy management server 208 may then transmit a RADIUS Access-Accept message 408 to the network access server 206. The RADIUS Access-Accept message 408 may include the list of apps 216 the user of the client 204 is authorized to access. Responsive to receiving the RADIUS Access-Accept message 408, the network access server 206 may grant the user access to the apps in the list, at 410.

The network access server 206 may collect usage data for each of the external apps 216 accessed by the user, at 412. The network access server 206 may occasionally report this usage data to the policy management server 208. In the example of FIG. 4, the network access server 206 may report the usage data by sending a RADIUS Accounting-Request message 414 to the policy management server 208. The RADIUS Accounting-Request message 414 may include the usage data. The network access server 206 may send RADIUS Accounting-Request messages 414 periodically. In some embodiments, the network access server 206 may send a RADIUS Accounting-Request message 414 at a fixed interval, e.g., every five minutes.

Responsive to receiving each RADIUS Accounting-Request message 414, the policy management server 208 may record the usage of each app 216, for each user, at 416. Responsive to each RADIUS Accounting-Request message 414, the policy management server 208 may send a RADIUS Accounting-Response message 418.

The policy management server 208 may check the usage of each app 216 for each user, at 420. For example, the policy management server 208 may compare the usage data recorded at 416 to the respective usage limits in the respective user profiles 210. In particular, the policy management server 208 may compare the reported usage of an app 216 by the user to the usage limit for that app 216 in that user's profile 210.

Responsive to the usage of an app 216 by a user meeting or exceeding the usage limit of that app 216 for that user, the policy management server 208 may revoke access to that app 216 by the user. In some embodiments, the policy management server 208 may revoke access by sending a Change of Authorization (CoA) message to the network access server 206, at 422. In some embodiments, the policy management server may revoke access by sending a Packet of Disconnect (POD) to the network access server 206, at 422. In this manner, the user may be disconnected from that app 216 in accordance with the usage limit for the user for that app 216.

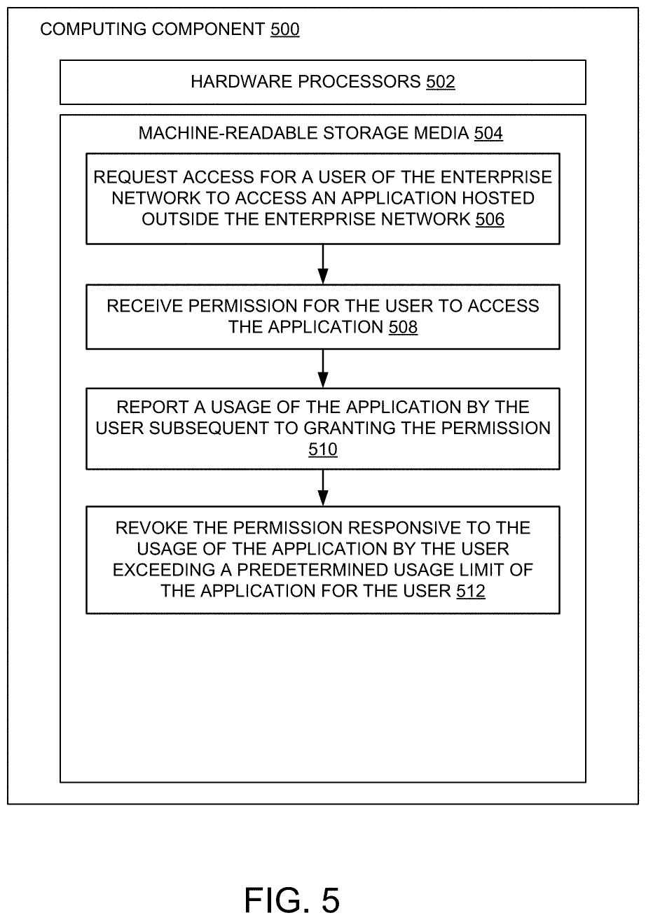

FIG. 5 is a block diagram of an example computing component or device 500 for network access enforcement in accordance with one embodiment. Computing component 500 may be, for example, a server computer, a controller, or any other similar computing component capable of processing data. In the example implementation of FIG. 5, the computing component 500 includes a hardware processor 502, and machine-readable storage medium 504. In some embodiments, computing component 500 may be an embodiment of the network access server 206 of FIG. 2.

Hardware processor 502 may be one or more central processing units (CPUs), semiconductor-based microprocessors, and/or other hardware devices suitable for retrieval and execution of instructions stored in machine-readable storage medium, 504. Hardware processor 502 may fetch, decode, and execute instructions, such as instructions 506-512, to control processes or operations for network access enforcement. As an alternative or in addition to retrieving and executing instructions, hardware processor 502 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 504, may be any electronic, magnetic, optical, or other physical storage device that contains or stores executable instructions. Thus, machine-readable storage medium 504 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 504 may be a non-transitory storage medium, where the term “non-transitory” does not encompass transitory propagating signals. As described in detail below, machine-readable storage medium 504 may be encoded with executable instructions, for example, instructions 506-512.

Hardware processor 502 may execute instruction 506 to request access for a user of the enterprise network 202 to access an application 216 hosted outside the enterprise network 202. This request may be made responsive to receiving a request from a user of a client 204 in the enterprise network 202. This request may be transmitted from the network access server 206 to the policy management server 208. In embodiments employing the RADIUS protocol, this request may be implemented as an Access-Request message according to the RADIUS protocol.

Hardware processor 502 may execute instruction 508 to receive permission for the user to access the application 216. This permission may be received by the network access server 206 from the policy management server 208. In embodiments employing the RADIUS protocol, this permission may be received as an Access-Accept message according to the RADIUS protocol. The Access-Accept message may include one or more attributes that identify the application 216. The attributes may be defined and implemented as Aruba networks vendor-specific attributes.

Hardware processor 502 may execute instruction 510 to report usage of the application 216 by the user subsequent to granting the permission. The network access server 206 may implement an operating system (OS), which may collect data representing the usage of each application 216 by each user. The OS may collect this data using deep packet inspection (DPI). This usage may be reported by the network access server 206 to the policy management server 208. The usage may include an amount of data, a period of time, an amount of time, and the like, or any combination thereof. In embodiments employing the RADIUS protocol, this report may be implemented as an Accounting-Request message according to the RADIUS protocol, where the Accounting-Request message specifies the usage of the application 216 by the user.

Hardware processor 502 may execute instruction 512 to revoke the permission responsive to the usage of the application by the user exceeding a usage limit of the application 216 for the user. The usage limit may include an amount of data, a period of time, an amount of time, and the like, or any combination thereof. This revocation may be implemented by disconnecting the user from the application 216. In embodiments employing the RADIUS protocol, this revocation may be implemented as a Change of Authorization message and/or a Packet of Disconnect according to the RADIUS protocol, may be implemented responsive to a Change of Authorization message and/or a Packet of Disconnect according to the RADIUS protocol, or any combination thereof.

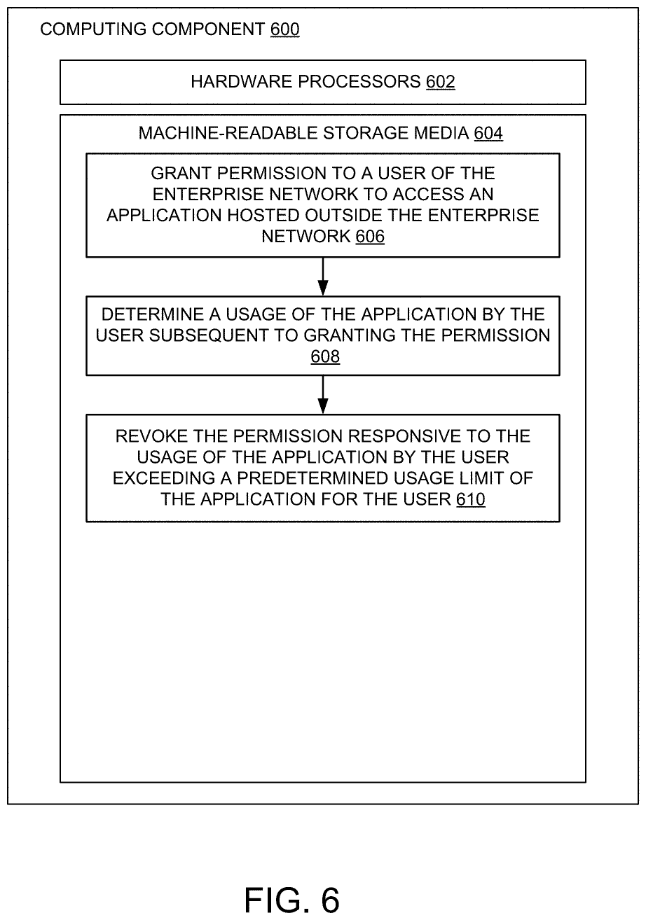

FIG. 6 is a block diagram of an example computing component or device 600 for network access enforcement in accordance with one embodiment. Computing component 600 may be, for example, a server computer, a controller, or any other similar computing component capable of processing data. In the example implementation of FIG. 6, the computing component 600 includes a hardware processor 602, and machine-readable storage medium 604. In some embodiments, computing component 600 may be an embodiment of the policy management server 208 of FIG. 2.

Hardware processor 602 may be one or more central processing units (CPUs), semiconductor-based microprocessors, and/or other hardware devices suitable for retrieval and execution of instructions stored in machine-readable storage medium, 604. Hardware processor 602 may fetch, decode, and execute instructions, such as instructions 606-610, to control processes or operations for network access enforcement. As an alternative or in addition to retrieving and executing instructions, hardware processor 602 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 604, may be any electronic, magnetic, optical, or other physical storage device that contains or stores executable instructions. Thus, machine-readable storage medium 604 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 604 may be a non-transitory storage medium, where the term “non-transitory” does not encompass transitory propagating signals. As described in detail below, machine-readable storage medium 604 may be encoded with executable instructions, for example, instructions 606-610.

Hardware processor 602 may execute instruction 606 to grant permission to a user of the enterprise network 202 to access an application 216 hosted outside the enterprise network 202. This grant may be implemented as a message transmitted from the policy management server 208 to the network access server 206. In embodiments employing the RADIUS protocol, this grant may be implemented as an Access-Accept message according to the RADIUS protocol.

Hardware processor 602 may execute instruction 608 to determine usage of the application 216 by the user subsequent to granting the permission. This determination may be made by the network access server 206. In embodiments employing the RADIUS protocol, this usage may be determined according to an Accounting-Request message received according to the RADIUS protocol, where the Accounting-Request message specifies the usage of the application 216 by the user.

Hardware processor 602 may execute instruction 610 to revoke the permission responsive to the usage of the application 216 by the user exceeding a predetermined usage limit of the application 216 for the user. This revocation may be implemented as a message transmitted by the policy management server 208 to the network access server 206. In embodiments employing the RADIUS protocol, this revocation may be implemented as a Change of Authorization message and/or a Packet of Disconnect according to the RADIUS protocol, responsive to a Change of Authorization message and/or a Packet of Disconnect according to the RADIUS protocol, or any combination thereof.

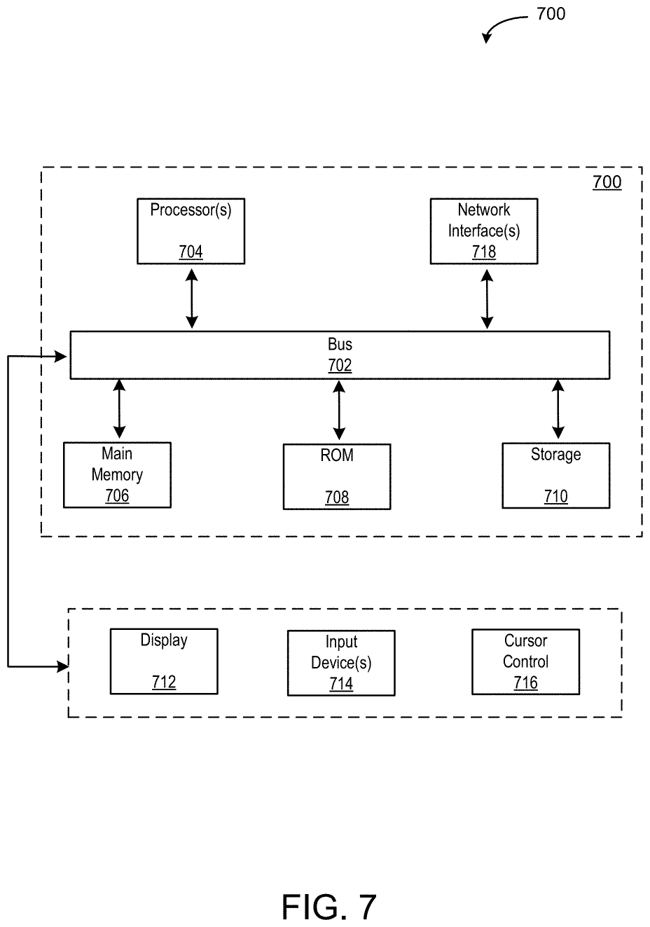

FIG. 7 depicts a block diagram of an example computer system 700 in which embodiments described herein may be implemented. The computer system 700 includes a bus 702 or other communication mechanism for communicating information, one or more hardware processors 704 coupled with bus 702 for processing information. Hardware processor(s) 704 may be, for example, one or more general purpose microprocessors.

The computer system 700 also includes a main memory 706, such as a random access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

The computer system 700 further includes a read only memory (ROM) 708 or other static storage device coupled to bus 702 for storing static information and instructions for processor 704. A storage device 710, such as a magnetic disk, optical disk, or USB thumb drive (Flash drive), etc., is provided and coupled to bus 702 for storing information and instructions.

The computer system 700 may be coupled via bus 702 to a display 712, such as a liquid crystal display (LCD) (or touch screen), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. In some embodiments, the same direction information and command selections as cursor control may be implemented via receiving touches on a touch screen without a cursor.

The computing system 700 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor(s) 704 executing one or more sequences of one or more instructions contained in main memory 706. Such instructions may be read into main memory 706 from another storage medium, such as storage device 710. Execution of the sequences of instructions contained in main memory 706 causes processor(s) 704 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 710. Volatile media includes dynamic memory, such as main memory 706. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 702. Transmission media can also take the form of acoustic or light waves, such as those generated during radio-wave and infra-red data communications.

The computer system 700 also includes a network interface 718 coupled to bus 702. Network interface 718 provides a two-way data communication coupling to one or more network links that are connected to one or more local networks. For example, network interface 718 may be an integrated services digital network (ISDN) card, cable modem, satellite modem, or a modem to provide a data communication connection to a corresponding type of telephone line. As another example, network interface 718 may be a local area network (LAN) card to provide a data communication connection to a compatible LAN (or WAN component to communicated with a WAN). Wireless links may also be implemented. In any such implementation, network interface 718 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through network interface 718, which carry the digital data to and from computer system 700, are example forms of transmission media.

The computer system 700 can send messages and receive data, including program code, through the network(s), network link and network interface 718. In the Internet example, a server might transmit a requested code for an application program through the Internet, the ISP, the local network and the network interface 718.

The received code may be executed by processor 704 as it is received, and/or stored in storage device 710, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 700.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A non-transitory machine-readable storage medium encoded with instructions executable by a hardware processor of a computing component, the machine-readable storage medium comprising instructions to cause the hardware processor to perform a method for a network access server in an enterprise network, the method comprising:
receive, from a user of the enterprise network, a request to access an application hosted outside the enterprise network;
responsive to the request, send an access request message to a policy management server for the enterprise network, the access request message identifying the application;
receive, from the policy management server, permission for the user to access the application;
report, to the policy management server, a usage of the application by the user subsequent to granting the permission; and
revoke the permission responsive to the usage of the application by the user exceeding a predetermined usage limit of the application for the user.

2. The medium of claim 1, wherein the usage limit includes at least one of:
an amount of data;
a period of time; and
an amount of time.

3. The medium of claim 1, wherein request permission comprises:
send an Access-Request message according to the RADIUS protocol.

4. The medium of claim 3, wherein receive permission for the user to access the application comprises:
receive an Access-Accept message according to the RADIUS protocol, wherein the Access-Accept message includes an attribute that identifies the application.

5. The medium of claim 1, wherein report a usage of the application by the user subsequent to granting the permission comprises:
send an Accounting-Request message according to the RADIUS protocol, wherein the Accounting-Request message specifies the usage of the application by the user.

6. The medium of claim 1, wherein revoke the permission comprises:
disconnect the user from the application.

7. The medium of claim 1, wherein revoke the permission comprises:
receive, according to the RADIUS protocol, at least one of a Change of Authorization message and a Packet of Disconnect.

8. A non-transitory machine-readable storage medium encoded with instructions executable by a hardware processor of a computing component, the machine-readable storage medium comprising instructions to cause the hardware processor to perform a method for a policy management server in an enterprise network, the method comprising:
send, to a network access server in the enterprise network, an access accept message responsive to receiving, from the network access server, an access request message, the access request message identifying a user of the enterprise network and an application hosted outside the enterprise network the user requested to access, wherein the network access server grants permission to the user to access the application responsive to receiving the access accept message;
determine a usage of the application by the user subsequent to granting the permission; and
revoke the permission responsive to the usage of the application by the user exceeding a predetermined usage limit of the application for the user.

9. The medium of claim 8, wherein the usage limit includes at least one of:
an amount of data;
a period of time; and
an amount of time.

10. The medium of claim 8, wherein the access accept message is an Access-Accept message according to the RADIUS protocol.

11. The medium of claim 10, wherein the Access-Accept message includes an attribute that identifies the application.

12. The medium of claim 8, wherein determine a usage of the application by the user comprises:
receive an Accounting-Request message according to the RADIUS protocol, wherein the Accounting-Request message specifies the usage of the application by the user.

13. The medium of claim 8, wherein revoke the permission comprises:
disconnect the user from the application.

14. The medium of claim 8, wherein revoke the permission comprises:
send, according to the RADIUS protocol, at least one of a Change of Authorization message and a Packet of Disconnect.

15. A system, comprising:
a hardware processor; and
a non-transitory machine-readable storage medium encoded with instructions executable by the hardware processor to perform a method for a policy management server in an enterprise network, the method comprising:
send, to a network access server in the enterprise network, an access accept message responsive to receiving, from the network access server, an access request message, the access request message identifying a user of the enterprise network and an application hosted outside the enterprise network the user requested to access, wherein the network access server grants permission to the user to access the application responsive to receiving the access accept message;
determine a usage of the application by the user subsequent to granting the permission; and
revoke the permission responsive to the usage of the application by the user exceeding a predetermined usage limit of the application for the user.

16. The system of claim 15, wherein the usage limit includes at least one of:
an amount of data;
a period of time; and
an amount of time.

17. The system of claim 15, wherein the access accept message is an Access-Accept message according to the RADIUS protocol.

18. The system of claim 17, wherein the Access-Accept message includes an attribute that identifies the application.

19. The system of claim 15, wherein determine a usage of the application by the user comprises:
receive an Accounting-Request message according to the RADIUS protocol, wherein the Accounting-Request message specifies the usage of the application by the user.

20. The system of claim 15, wherein revoke the permission comprises:
disconnect the user from the application.
